(19) United States
(12) Patent Application Publication
(10) Pub. No.: US 2024/0188557 A1
(43) Pub. Date: Jun. 13, 2024

(54) PEST MANAGEMENT SYSTEM

(71) Applicant: BIRDSOL PTY LTD, Urrbrae (AU)

(72) Inventor: George Karounos, Urrbrae (AU)

(21) Appl. No.: 18/555,687

(22) PCT Filed: Apr. 14, 2021
(86) PCT No.: PCT/AU2021/000033

§ 371 Date: Oct. 16, 2023

(30) Foreign Application Priority Data
Apr. 14, 2020 (AU) 2020901184

(51) Int. Cl. A01M 29/00; A01K 29/00; G06F 18/22

(52) U.S. Cl. CPC A01M 29/00; A01K 29/005; G06F 18/22

(57) ABSTRACT

The invention concerns a pest management system especially suited for the protection of crops. The pest management system can identify a particular pest species and use species-specific remedies to deter invasion of a crop or orchard area or to entice the pest species away from the crop or orchard area. In some embodiments, a deterrent system is used in conjunction with an enticement system. Part of the basis of the invention is the ability to communicate with a pest species in order to influence its behaviour.

### FIELD OF THE INVENTION

This invention relates to a system for managing pests. In particular, the invention is concerned with a system which is capable of influencing pests to move away from or towards a location.

For convenience below, the invention will often be described in relation to its use in managing bird or bat pests. However, it is to be understood that this does not limit the scope of the invention to pests being birds or bats.

### BACKGROUND OF THE INVENTION

Pests such as birds are undesirable in a variety of situations. For example, in agriculture, birds can damage or, in some cases, destroy crops, costing the industry many millions of dollars annually in Australia alone. Birds roosting on buildings, especially high-rise commercial buildings, leave droppings which are unsightly and which can cause damage to surfaces. Domestically, birds can attack woodwork around windows and on balconies, causing considerable structural damage.

There have been attempts to alleviate the problems caused by birds. Physical barriers have included netting of some crops. For fruit tree orchards, netting still permits bird access under the netting. For crops with small fruit, birds can often reach through netting and remove fruit. Installation of bird spikes on buildings is partially successful, but some birds are adept at attacking and damaging spikes so they no longer provide a barrier.

Lethal solutions include shooting, trapping, and baiting.

Some commercial bird deterrents use audible sounds in an attempt to deter bird pests. However, a major problem with these is that birds quickly become desensitized to the sounds and ignore them after an initial period. This is known as habituation, which is a type of learned behaviour found in many life forms. The response to a deterrent can diminish as the deterrent becomes familiar. A well-known example for crows is the response to the presence of a scarecrow. Initially, the crows will regard the scarecrow as a threat and will fly away from the locality of the scarecrow. Eventually, the crows will become familiar with the scarecrow and ignore it as a threat, even to the extent of roosting on the scarecrow.

In situations where food is scarce, such as during periods of drought, birds can be more aggressive in seeking food and less susceptible to being deterred by currently-known non-lethal deterrents.

Bats, similarly to birds, can also cause considerable damage to commercial crops—between 5 and 100%, according to some reports.

There is considerable conflict between fruit growers and fruit bats. Currently, the most effective means of preventing bat damage to crops is the use of fixed nets. However, the use of fixed nets has several issues and is not a straightforward solution for every situation. The use of netting is expensive, sometimes visitation occurs before nets can be put up, nets require replacement every few years, and bats have been observed crawling underneath netting and causing damage and soiling of produce when landing on the net.

Other considerations may limit the ways in which fruit orchards can be protected from bats. For example, the grey-headed flying fox, a member of the fruit bat family Pteropodidae, is a native species in Australia and listed as vulnerable under national environment legislation. It has a wing span of about 1.5 metres and adults weigh up to 1.1 kg.

Each night they fly 50 kilometres or more to find food, including native fruits, flowers, pollen, nectar and some types of leaves. They have been recorded feeding on more than 200 types of native plants in 50 families. They also feed on non-native trees and fruit orchards. They are regarded as ecologically important species because they have keystone roles for pollination and seed dispersal.

There is currently no standard deterrent for flying-foxes on commercial orchards, other than fixed netting, but this is not fully effective and may not always be cost effective.

Depending on how the netting is arranged on trees, for example if simply draped over the foliage without support, flying-fox entanglement, injury and death can occur.

As a result, a deterrent solution must be non-lethal and humane as well as being highly effective.

While birds cause damage to crops during daylight hours, bats are active at night, a factor to be taken into account when devising a pest management system.

Different pest management systems have suggested use of noises and lights to deter birds from causing damage to crops and orchards. However, prior art systems have been ineffective because they have not sufficiently overcome the habituation factor: birds will readily recognise that sounds or lights which are repetitive, or which come from a fixed location, are not a threat and birds will ignore them.

It is therefore an object of the present invention to provide a pest management system which overcomes or alleviates the problems associated with the prior art or which at least provides a useful alternative.

### SUMMARY OF THE INVENTION

The present invention recognises that there are considerable advantages in devising a pest management system that can identify a particular pest species and use species-specific remedies to deter invasion of a crop or orchard area or to entice the pest species away from the crop or orchard area. In some embodiments, a deterrent system is used in conjunction with an enticement system.

Part of the basis of the invention is the ability to communicate with a pest species in order to influence its behaviour.

Accordingly, the present invention provides a pest management system which includes:
a sensor for sensing presence of a pest in a selected location;
identifying means for capturing a pest feature, comparing the pest feature with features in a first reference library and thereby identifying the pest species;
selection means for selecting an influencing factor for the identified pest species from a second reference library containing influencing factor data;
means for exposing the identified pest species to the influencing factor for that species; and
means to reduce complacency of the identified pest species with respect to the influencing factor.

The present invention also provides a method of managing a pest, the method including the steps of:
sensing via a sensor a presence of a pest in a selected location;
capturing a feature of the pest, comparing the pest feature with features in a first reference library and thereby identifying the pest species;
selection an influencing factor for the identified pest species from a second reference library containing influencing factor data;
exposing the identified pest to the influencing factor for that species; and
using means to reduce complacency of the identified pest species with respect to the influencing factor.

The pest to be managed may be chosen from a wide range, including birds, rodents, bats, foxes, deer, sharks and insects, especially termites, locusts and grass hoppers. As indicated above, for convenience of illustration, the disclosure below will often focus on birds or bats as the pest.

In the embodiments where birds are the pests, the best birds may be, for example, magpies, cockatoos and/or rosellas.

Management of the pest species is not limited to deterring the pest from the selected location. The system of the invention may operate to entice the pest species away from the location, or to deter the pest species from remaining in the location, or both.

The sensor, which senses presence of a pest in a selected location, may carry out its sensing function in many different ways. For example, the sensor may detect presence of the pest by capturing one or more images of the pest, by detecting a pattern in its flight or other movement, by detecting sounds (such as wing noise, noise calls) or by detecting motion. Other types of sensing are possible, including heat sensing.

Preferably, the system includes a plurality of sensors. Each sensor may work with the identifying means to capture an image of the pest, a vocal signature of the pest and kinematics in relation to the pest, in order to identify the pest. The sensor may sense presence of the pest when moving towards or away from the selected location.

Combinations of sensing are included, such as sensing of both image and sound/s.

The selected location is that relevant to the pest management. In an agricultural context, for example, the selected location may be a crop or an orchard. The invention is not limited to such examples.

The pest feature may be chosen from a range of features, including an image, a flight pattern, a flock pattern in flight or a sound made by the pest, whether vocal or not. The pest feature may consist of a combination of features.

The identifying means may be separate from, or may include, the sensor. For example, the identifying means may be a video camera which is activated by the sensor to record the pest feature, being in this example images of the pest in flight. The images may then be compared with those in the first reference library in order to identify the pest from its image.

In another embodiment, the identifying means is combined with the sensor which detects a sound associated with the pest, such as the noise call of the pest. The identifying means then compares the noise call with those in the first reference library of noise calls, in order to identify the pest.

The first reference library is preferably a database of pest features, preferably held in a remote cloud, with which the identifying means communicates using a suitable processor and communication link which enables data exchange, using known information exchange protocols. Data may be encrypted as desired.

The first reference library may include a combination of pest features, to more accurately identify the pest species.

The database in the first reference library may be augmented and improved by artificial intelligence processing, using pattern recognition, kinematics recognition, sonographic recognition, direction determination and reinforcement learning, for example. In one embodiment, the database includes non-pest features, such as images or videos of large leaves being moved during windy days, or fast moving wispy clouds, so that the artificial intelligence processor learns not to identify these as birds.

The selection means is able to select an influencing factor for the identified pest species from a second reference library containing influencing factor data for that species (as well as data for different species as required). An influencing factor may be chosen from one of more different factors. For example, if the influencing factor is for the purpose of deterring the pest from remaining in the selected location, negative influencing factors are relevant. The influencing factor may be chosen to cause fear, discomfort or distraction to the pest.

It is a feature of the present invention, being species-specific, that playback of sounds can be tailored for any given species to elicit the most desired response. This can include species-specific calls or call types of different species that are recognised by the problem/target species (e.g., alarm and distress calls).

In some embodiments, where the pests are birds, influencing factors may be sounds. The sounds may be sounds emitted by the same species, such as alert sounds. The sounds may be those of predators for the pest birds. For example, if the pest bird is a rosella, the predator sound may be that of a peregrine falcon, a wedge tail short or a whistling kite (or any raptor). The sounds may be those of species hated by the pest birds. Examples of hated birds for rosellas as the pest bird are noisy miners and white plumed honey eaters, both of which are aggressive towards small parrots including rosellas, and cockatoos. The sounds may be those of the same species as the pest, being sounds of that species under threat or under stress (e.g., a rosella held in the hand or captured by predator) or threat (sighting of terrestrial or airborne predator in relative vicinity).

Field test research has revealed that Australian passerines (e.g., Magpies, Nosy Miner, other honeyeaters) give alarm calls in response to sighting of terrestrial or airborne predators (including live tame raptors and predator models). These alarm calls differ, depending on predatory type (aerial vs ground predator) or behaviour (raptor in flight vs perched), providing information of predator type, level of predator threat and response required from recipients. Recordings of such alarm calls and exposure of such species to them can prove effective deterrents.

Most honeyeaters (e.g., red wattlebird, noisy miner), Australian Magpie, Magpie-lark, as an example of some bird species, are aggressive with agnostic behaviour directed towards other bird species, especially during breeding season, individually or as a group, directed at birds larger and smaller than themselves.

Any raptor species particularly falcons (Peregrine Falcon) and sparrowhawks/goshawks are specialist bird hunters with birds such as parrots (rosellas, lorikeets) forming a significant part of their diet. Identification of rosella or lorikeet species as the invading pest can be deterred by exposure to noises made by raptor species.

Non-limiting examples of negative influencing factors which may be used in addition to those selected for the identified species are predator sounds (where the predator is not species-specific), loud noises such as gunshots, sounds of nuisance elements (such as humans) vibrations, and lights or intermittent light patterns.

In preferred embodiments, more than one negative influencing factor is selected.

In some embodiments, where negative influencing factors are sounds and the pests are birds, a random mix of sounds may be emitted. In these embodiments, it is preferred that the first sound emitted in a sequence of sounds is a gunshot sound or a predator sound for the species. This is particularly preferred when the pest birds are local birds as opposed to visiting birds, or when the pest birds are large parrots. The balance of the sequence of sounds, preferably randomly mixed, can then follow.

Ideally, sounds are short and sharp to communicate more effectively to the bird pests.

If the influencing factor is for the purpose of enticing or attracting the pest away from the selected location, positive influencing factors are relevant.

Non-limiting examples of positive influencing factors are: sounds made by the identified pest when in an environment providing plentiful food and/or shelter and/or safety from predators.

In preferred embodiments, more than one positive influencing factor may be selected.

It is preferred that, in the case of use of positive influencing factors, the pest species is ‘rewarded’ if it obeys the positive influencing factor. For example, if the pest is a bird, it may be enticed by sounds made by the identified pest species when in an environment providing plentiful food and/or shelter, and lead to an aviary location where the food and/or shelter is actually provided.

The second reference library is preferably a database of influencing factors with which the selection means communicates using a suitable processor and communication link which enables data exchange, using known information exchange protocols. Data may be encrypted as desired.

The second reference library may include the whole vocal repertoire of each pest species that will act as either deterrent or attractant calls. Deterrent or negative calls includes anti-predator calls (alarm calls emitted in different contexts and to predators, distress calls when caught/held in the hand, mobbing predator calls as well as territorial/agonistic calls).

Attractant calls, used to communicate with a bird species in order to entice them to a different location, may indicate plentiful food and/or shelter, mating, social facilitation, nesting and juvenile begging, for example. Birds produce song (or equivalent) during ritualised mating-related behaviours (sometime accompanying visual displays) to entice females into a territory and as an expression of genetic fitness level. Some social facilitation calls are also produced during feeding or signalling that a food source has been located (parent to juvenile). The second reference library may include recordings of these for identified species, for playback.

If one or more drones are used in the system of the invention, at a chosen point the drone may take over from stationary speaker units described below and produce alarm, distress, agonistic and/or predator calls for the identified species. The chosen point may be the orchard boundary or just outside it, to continue to “move the birds along” in the right direction. In one embodiment, as the birds move in the direction towards a feeding sanctuary (for example) the drone may switch to “attractant” calls to entice the birds towards the desired location. Once close enough to the sanctuary, a stationary speaker unit system may take over to entice the birds to the sanctuary.

The first and/or second reference libraries may be held in a remote ‘cloud’ or may be located locally on a gateway device, for example.

Location of the first and second reference libraries in the ‘cloud’ or otherwise remotely from the hardware in the selected location can be beneficial if the hardware is stolen, because the system can be programmed to prevent unauthorised access to the reference libraries in such circumstances. The stolen hardware will therefore have little value.

The means for exposing the identified pest species to the influencing factor will depend on the nature of the influencing factor. For example, if the influencing factor is a sound, in one embodiment the exposing means is a speaker, more preferably a plurality of speakers, designed to broadcast the influencing factor. The speakers are preferably located at spaced intervals in or around the selected locations. For example, speakers may be installed in the canopy of vines, trees, shrubs or bushes.

In one embodiment, a set of speakers is located at each spaced interval. Each set of speakers may consist of 4 or 8 speakers in this embodiment. In the case of 4 speakers, one speaker may face in each of north, south, east and west, to provide 360 degree coverage. In the case of 8 speakers, two speakers may face in each of north, south, east and west, to provide 360 degree coverage.

If desired, one or more speakers may face upwardly. Such speaker or speakers may be in addition to those referred to in the last paragraph or may be one of those already referred to.

Speakers, within a set of speakers or from one spaced interval to another, may be programmed to emit the desired sounds at different points in time. The purpose of this may be to provide the pest species with the impression that it is being chased (in the case of negative sounds) or being drawn towards a different location (in the case of positive sounds). If the speakers in a set of speakers are programmed so that sounds from one speaker are slightly offset from the other speakers, a staccato effect may be produced, which makes it difficult for the birds to pinpoint where the sounds are coming from.

Speakers may be mounted in any suitable manner. An example which may be applicable to agricultural or horticultural situations is to mount speakers on star posts. Another example is to mount speakers on trees in an orchard.

Speakers may be powered by batteries. If the batteries are heavy and not suited to being mounted on star posts or on trees, the batteries may be located on the ground nearby, for instance.

If preferred, the speakers may be powered using solar panels. The means to reduce complacency of the identified pest with respect to the influencing factor is intended to avoid, delay or reduce habituation of the pest species to the influencing factor. The means may operate in many suitable ways.

In another embodiment, speakers may be mounted on airborne devices, such as drones. This embodiment is described in greater detail below. Airborne devices may be used instead of ground based units but it is preferred that airborne devices supplement ground based units.

In one embodiment, where the influencing factor includes sounds, the means to reduce complacency may include a plurality of sounds, mixed together and/or played sequentially.

An example is a sequence commencing with a noise made by a predator for the pest species or a gunshot sound, followed by sounds emitted by nuisance elements, such as bothersome birds for the species. Preferably, a number of ‘bothersome bird’ sounds are mixed together. Even more preferably, sounds are mixed randomly from a menu.

It is particularly preferred that responses of the pest species to the influencing factor are recorded by the sensing means and communicated to an artificial intelligence or machine learning processor which accordingly changes the action of the means to reduce complacency, to improve or enhance its effectiveness. Thus, in the example of emission of sounds, there may be changes in loudness, length of time of emission and/or the selection and/or mix of sounds. This may occur in real time for maximum effect in managing the pest.

In one embodiment, when birds enter an orchard and the species is identified, the system of the invention may cause the selected calls be emitted at their loudest (without introducing distortion). Deterring problem species as they enter an orchard is the first line of defence. If the system of the invention detects that the species has moved to another area of the orchard, another speaker that is closest to the birds may be triggered. Using a multiple speaker method may compensate for the need to increase sound amplitude (i.e., loudness) and thereby prevents undesirable variables such as distortion.

In another embodiment, different alarm calls (from different individuals of the same species or from different species) are played back randomly from different speakers, to convey the message that more than one prey species has sighted a potential predator or that the perceived predator is on the move and therefore still a threat. Further, alarm calls may be produced in a staccato sequence, as may occur in the wild, to provide the context of predatory threat.

The single or multiple speaker playback scenario described above may also be used to entice the species away from the orchard, using positive messages.

In one embodiment of the system of the invention, several self-contained units are used at the selected location. Each unit may contain a camera activated by a motion detector, an array of speakers, such as 4 speakers, a battery backup for one or more solar panels and an amplifier attached to the array of speakers, for varying volume of emitted sounds.

Preferably, the system is of flexible and modular construction, having a plug and play architecture that allows for addition or removal of system parts for easy change of capabilities, for instance.

Communication is implemented as required, such as by using local gateways and/or cloud infrastructure. For interconnectivity, the system may have the ability to use 4G/5G or Wi-Fi to a gateway for connection to the cloud.

Any artificial intelligence processor may be installed locally instead of or as well as on cloud infrastructure.

Once the system of the invention has detected that the pests have left the selected location, the system preferably ceases to use the influencing factors. But if the pest has remained in the selected location, the system may use a different sequence of the influencing factors, such as emitting via speakers a different sequence of sounds.

When the system includes artificial intelligence processing, it learns the most effective influencing factors to use for an identified pest species and how best to reduce or eliminate habituation for that pest species.

Selection of influencing factors may be based on the probability that the chosen influencing factor/s will cause the pest species to leave the selected location. The system of the invention may issue an alert when the success of the influencing factor/s falls below a chosen threshold, at which time the influencing factors may be reviewed or updated to reduce habituation and increase effectiveness.

### BRIEF DESCRIPTION OF THE DRAWINGS

A preferred embodiment of the present invention will now be described with reference to the accompanying drawings. It is to be understood that the embodiment described is not intended to be limiting on the scope of the invention. Changes, modifications and variations may be made without departing from the spirit and scope of the present invention.

In the drawings:

FIG. 1 is a diagrammatic depiction of part of the system of the invention;

FIG. 2 is an aerial view of a selected location, being an orchard;

FIG. 3 is a graph illustrating bird visitations to the selected location over a stated period; and

FIG. 4 is a graph showing success in management of bird visiting the selected location.

### DESCRIPTION OF THE PREFERRED EMBODIMENTS

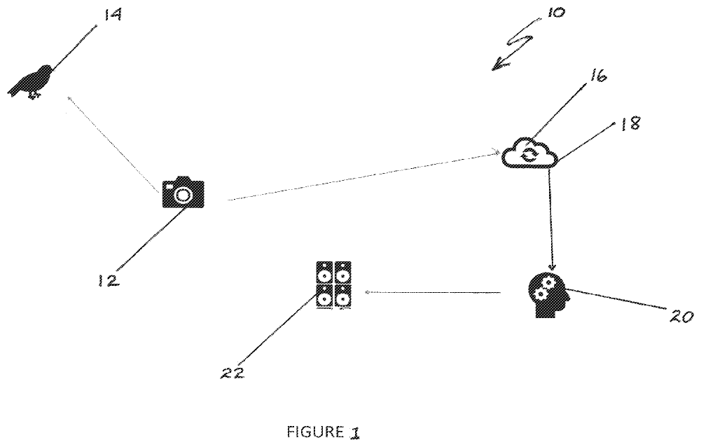

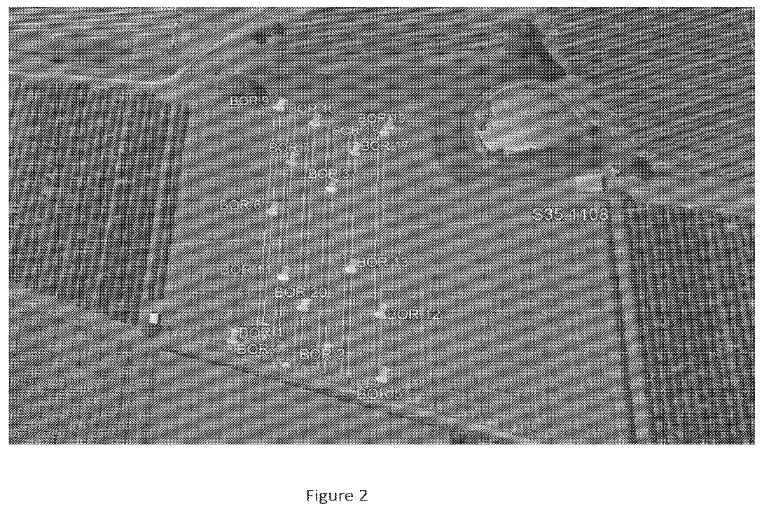

Referring first to FIG. 1, pest management system 10 has a video camera 12 which includes a sensor for sensing presence of a bird pest 14 in flight in a selected location (the orchard in FIG. 2).

Camera 12 is part of a unit which includes speaker unit 22.

Camera 12 captures images of bird 14 in flight and communicates the images to a first reference library 16 stored in cloud 18. The captured bird images are compared with images in first reference library 16 and the bird is identified as a rosella species.

The information regarding identification of the rosella species is transmitted to artificial intelligence processor 20, which selects a sequence of influencing factors for the rosella from a second reference library (not shown, in communication with processor 20).

Processor 20 then communicates the selected sequence of influencing factors to speaker unit 22, shown as having 4 speakers. Speaker unit 22 is one of several speaker units as explained in connection with FIG. 2, below. Speaker unit 22 is depicted diagrammatically in FIG. 2 but in fact has its 4 speakers arranged to point north, east, west and south, with one of these also pointing upwards.

In this embodiment, the influencing factors are sounds. The sequence of sounds commences with a sound of a cry of an approaching predator for the rosella—in this instance, a peregrine falcon. There follows a randomised sequence of cockatoo shrieks, cockatoos being a species hated by rosellas. The system programmes the sequence to be emitted from speaker unit 22, with a slight delay from one of the 4 speakers. The sequence is also emitted from one or more of the other speaker units, in such a way as achieve a desired outcome. For example, if the rosellas are detected at one end of the selected location, the system send the sequence to the speaker units 22 using timing which will effectively ‘chase’ the rosellas out of the selected location by the shortest route.

If no rosella is being detected by any camera 12, the system understands that all the rosellas have left the orchard and the sounds are stopped.

If any camera 12 detects the presence of a rosella still present in the orchard, this is communicated to processor 20, which chooses a new randomised sequence of sounds and sends these to the speaker units 22. The new sequence may include sounds of the same predator species and hated species as before, but using different sound files for those species. Alternately, the sequence may include sound of a different predator species or hated species, or a mixture of both types of predators and hated species.

Another option is to include a gunshot, in a sequence or alone, especially if rosellas are still being detected in the orchard.

The loudness of the sounds is adjusted according to the site, until the desired effect is achieved.

Effectiveness of any sequence is monitored and measured by processor 20, in accordance with whether the birds leave the selected location (success) or stay in the selected location (failure). The system 10 will modify the sequences recipe being played through speaker units 22 until a success criterion is met or a timeout occurs. The results of the playback are used to update the weighting on the initial sound sequences and the system 10 is re-armed, ready for the next intrusion into the protected area by the target species.

FIG. 2 shows the selected location (in the Adelaide Hills, South Australia), which is a 1.5 hectare unnetted orchard containing apples of two varieties, Bravo and Pink Lady.

In the orchard, 19 units were installed. These are identified in FIG. 2 using the labels BOR-1 to BOR-19. Each such unit consisted of:
a 4-speaker array;
a single 120-degree 4 MP camera with fixed focal length, motion activated;
a microphone array;
a 20 W solar panel installation for each camera;
a 90 AH battery backup in an easily accessible location; and
4G connection from each BOR unit to the cloud infrastructure.

It will be noted that in FIG. 2 the BOR units are arranged in the orchard in a non-symmetrical manner, with more units around the periphery of the orchard.

In an alternate configuration to that described above in relation to FIG. 1, the BOR units may themselves contain the identifying means for capturing the pest feature, for comparing the pest feature with features in a first reference library and thereby identifying the pest species. Rather than the image captured by camera 12 being communicated to reference library 16 stored in cloud 18, the captured image is processed by the BOR unit, which runs basic bird detection algorithms, thus reducing the bandwidth required to support the system.

In the case of this alternate configuration, there is a two-way communication between the BOR unit and processor 20, which still selects influencing factors and mixing of sounds for complacency reduction.

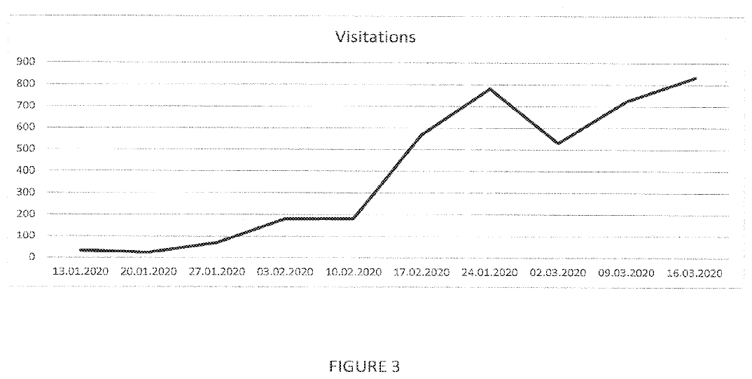

FIG. 3 is a graph illustrating rosella visitation numbers to the orchard in FIG. 2 over the period from 13 Jan. 2020 to 16 Mar. 2020. In the orchard, the pink lady apples ripened first. Bird visitations increased as the pink ladies ripened, until late February 2020, when these were picked. At that time, bird visitations dropped off, then rebounded as the bravo apples ripened.

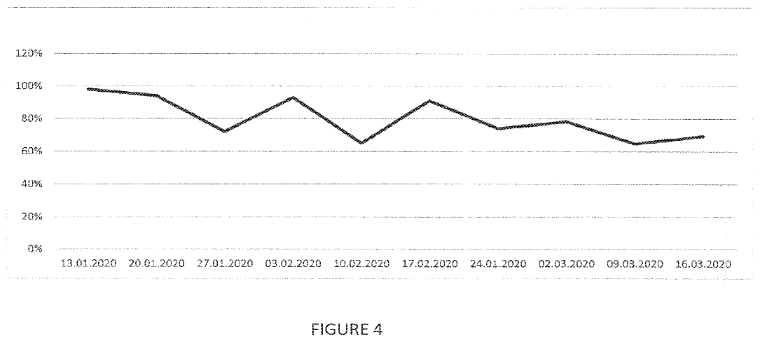

The effectiveness of system 10 is shown in the graph in FIG. 4, which plots % effectiveness against date. Instead of the birds becoming habituated to the same sounds being repeated at intervals, FIG. 4 shows that the use of a changing mix of influencing sounds minimises habituation and results in an average effectiveness of about 80%, over the ripening period of about 2 months.

In another embodiment, the system of the invention includes one or more intelligent airborne devices, preferably as a supplement to the ground-based BOR units described above. Preferably, the airborne device is a drone.

Each drone may have capacity to sense presence of a pest in the selected location even at night or in poor light, for example by using one or more thermal sensors. The drone may have identifying means for capturing a pest feature, for example, using a camera to capture an image of the pest. The drone may send the image electronically to an external first reference library for identification of the pest species.

Software controlling the system of the invention may then select one or more influencing factors for the species from the second reference library and instruct the drone to expose the species to the influencing factor. The drone is able to direct influencing factors being sounds through one or more speakers mounted on the drone. The drone can mimic the action of a predator for the species by approaching the species from the air while emitting recorded predator cries, for example.

The drone may carry strobe and spotlight features which can be used to chase a pest species out of the selected location.

If the pest species is to be exposed to a positive influencing factor, the drone may use its speakers to expose the pest species to attractant calls while at the same time moving away from the selected location towards another location where, preferably, the pest species is rewarded by a feeding table and a predator-free environment.

In this embodiment, the drone has a dual camera which captures red-green-blue (RGB) bands of light and thermal sensors. The RGB capacity marries well with the identification of species step in the method of the invention

Examples of a drone suitable for use in the system of the invention are the Mavic Pro 2 Enterprise, supplied by Hover UAV, located at 4/76 Township Drive, Burleigh Heads, QLD, 4220, Australia. This automated drone is a multi-rotor aircraft weighing less than 2 kg and with a range of up to 6 km. It has a dual camera which employs both RGB and thermal sensors. It has a modular pack which includes a strobe, a spotlight and a speaker of up to 10 W.

The Mavic drone has an obstacle-sensing system to avoid collisions, with 8 visual spectrum high resolution sensors and 2 infra-red sensors.

Bespoke software may be uploaded to onboard storage on the drone or a parallel system may be run on a smart device or computer system.

The drone may be recharged through a charging pad hardware platform.

A further embodiment will now be described, where the pest is a bat, the species being the grey-headed flying fox (GHFF) described earlier.

In this embodiment, a sacrificial alternate feeding area is provided at a sanctuary located away from the fruit orchard to be protected. The sacrificial feeding area may be another orchard or feeding area, consisting of any type of pulpy and soft-skinned fruit (figs, apples, peaches and pears). Fruit bats will also eat overripe, unripe or damaged fruit including fruit that is being eaten by insects. The main natural food source for bats is pollen and nectar (e.g., flowering eucalypts) and they also act as important pollinators. The sanctuary can provide either or both, depending on the location and available resource.

Since the GHFF feeds at night, the sensor for sensing its presence is preferably a thermal sensor or a motion detector. Once identified as GHFF species via the first reference library, the influencing factors are identified by the second reference library.

For GHFF, negative influencing factors include the calls of large diurnal and nocturnal raptors (i.e., eagles and Powerful Owl), which are known predators for the species. Other negative influencing factors are distress calls, such as emitted by a GHFF when held in the hand. Industrial noises may also be included.

Attractant calls may include vocal communication between parent-young, which is an important aspect of the parent-offspring bond, as well as calls made during mating rituals to attract females and also during the act of mating.

A focused broadcast of negative influence sound is directed to the GHFF once identified, to deter the GHFF from entering into or remaining in the orchard. The sound may be broadcast from stationary speakers and/or from drones, as described above for other embodiments. Positive sounds are directed towards the GHFF, leading or herding the GHFF towards a sanctuary. Preferably, the sanctuary is an area identified and dedicated as such by regional fruit growers who can contribute the damaged fruit used to provide the alternate feeding area in the sanctuary.

It will be appreciated that this embodiment of the invention provides an ethical, non-lethal deterrent together with an alternate food source, suitable to alleviate the serious damage caused by the GHFF to fruit crops while avoiding physical harm to the GHFF.

In each of the embodiments described above, the second reference library may be programmed to provide a different set of influencing factors for the pest species, immediate or at next visit, if required to avoid habituation

### INDUSTRIAL APPLICABILITY

Embodiments of the invention can provide a novel solution to damage caused by pests in agriculture, horticulture, industry and domestically. The invention is non-lethal. It can be adapted to a wide range of situations.

1. A pest management system for reducing or preventing pest damage to a selected location being a crop or an orchard, the system including:
a sensor for sensing presence of a pest in the selected location;
identifying means for capturing a pest feature, comparing the pest feature with features in a first reference library and thereby identifying the pest species;
selection means for selecting positive and negative influencing factors for the identified pest species from a second reference library containing influencing factor data;
means for exposing the identified pest species to at least one negative influencing factor for that species; and
means for exposing the identified pest species to at least one positive influencing factor for that species.

2. The pest management system of claim 1, which includes means to reduce complacency of the identified pest species with respect to the influencing factor.

3. The pest management system of claim 1, wherein the pest is chosen from the group consisting of birds, rodents, bats, foxes, deer, sharks and insects, including termites, locusts and grass hoppers.

4. The pest management system of claim 1, wherein the pest species is rosella, magpie, magpie-lark, cockatoo or grey-headed flying fox.

5. The pest management system of claim 1, wherein the negative influencing factor is adapted to deter the pest species from remaining in the selected location.

6. The pest management system of claim 1, wherein the positive influencing factor is adapted to entice the pest species away from the selected location.

7. The pest management system of claim 1, wherein the sensor is adapted to detect presence of the pest by capturing one or more images of the pest, by detecting a pattern in its flight or other movement, by detecting one or more sounds, by detecting motion or by heat sensing.

8. The pest management system of claim 1, wherein the pest feature is chosen from an image, a flight pattern, a flock pattern in flight, a sound made by the pest or a combination of any of the foregoing.

9. The pest management system of claim 1, wherein the identifying means includes the sensor.

10. The pest management system of claim 9, wherein the identifying means is a motion-activated video camera.

11. The pest management system of claim 1, wherein first reference library is a database of pest species features.

12. The pest management system of claim 1, wherein the second reference library is a database of influencing factors for identified pest species.

13. The pest management system of claim 1 wherein the influencing factors include predator sounds, loud noises, sounds of nuisance elements, vibrations, lights, intermittent light patterns and sounds made by the identified pest when in an environment providing plentiful food and/or shelter and/or safety from predators.

14. The pest management system of claim 2, wherein the influencing factor includes sounds and the means to reduce complacency includes a plurality of sounds, mixed together and/or played sequentially.

15. The pest management system of claim 14, wherein the plurality of sounds is mixed randomly from a menu.

16. The pest management system of claim 15, wherein the random mixing is chosen from the menu in response to reaction of the pest species to the influencing factor.

17. The pest management system of claim 14, wherein the means to reduce complacency includes at least one of changes in loudness, length of time of emission and/or the selection and/or mix of sounds.

18. The pest management system of claim 17, wherein the means to reduce complacency occurs in real time for maximum effect in managing the pest.

19. A method of managing a pest, for reducing or preventing pest damage to a selected location being a crop or an orchard, the method including the steps of:
sensing via a sensor a presence of a pest in the selected location;
capturing a feature of the pest, comparing the pest feature with features in a first reference library and thereby identifying the pest species;
selecting positive and negative influencing factors for the identified pest species from a second reference library containing influencing factor data;
exposing the identified pest species to at least one negative influencing factor for that species; and
exposing the identified pest species to at least one positive influencing factor for that species.

20. The method of claim 19, which includes using means to reduce complacency of the identified pest with respect to the influencing factor.

21. The method of claim 19 when carried out using the system of claim 1.

22. A management system when used to reduce or prevent damage by birds to a selected location being a crop or an orchard, the system including:
a sensor for sensing presence of a bird in the selected location;
identifying means for capturing a bird feature, comparing the bird feature with features in a first reference library and thereby identifying the bird species;
selection means for selecting positive and negative influencing factors for the identified bird species from a second reference library containing influencing factor data;
means for exposing the identified bird species to at least one negative influencing factor for that species, such that the pest species is deterred from damaging the crop or orchard;
means for exposing the identified bird species to at least one positive influencing factor for that species, such that the pest species is enticed away from the crop or orchard; and
means to reduce complacency of the identified bird species with respect to the influencing factor;
wherein the means to reduce complacency is adapted to operate in real time for maximum effect in managing continued presence of the bird in the crop or orchard during a single visit.
